(19) United States
(12) Patent Application Publication
(10) Pub. No.: US 2026/0154905 A1
(43) Pub. Date: Jun. 4, 2026

(54) BASE BODY DETECTION WITHIN A VIRTUAL PLATFORM

(71) Applicant: Roblox Corporation, San Mateo, CA (US)

(72) Inventor: Phani Harish WAJJALA, San Mateo, CA (US)

(73) Assignee: Roblox Corporation, San Mateo, CA (US)

(21) Appl. No.: 18/967,271

(22) Filed: Dec. 3, 2024

(51) Int. Cl. G06T 17/20

(52) U.S. Cl. CPC G06T 17/20

(57) ABSTRACT

Various implementations relate to methods, systems, and computer-readable media for detecting policy-violating content in user-generated avatar bodies on a virtual platform. According to one aspect, a computer-implemented method includes obtaining a user-generated avatar body with a 3D mesh and texture and providing the avatar body and a set of text questions to a multimodal machine-learned model. Each text question pertains to a characteristic relevant to content policy. The model generates probability values indicating the likelihood of each characteristic being present in the avatar body. A decision model evaluates the probability values to determine if the avatar body violates content policy. Based on the determination, usage of the avatar body on the virtual platform is controlled, including potential restrictions or flagging for manual review.

### TECHNICAL FIELD

Implementations relate generally to content moderation in virtual platforms, and more specifically but not exclusively, relate to methods, systems, and computer-readable media to detect unauthorized content in user-generated avatar bodies.

### BACKGROUND

User-generated content within virtual platforms has gained significant popularity, especially with the rise of customizable avatars and digital virtual assets. Such platforms enable users to design, modify, and share avatar bodies and accessories, creating a rich digital environment where users can express their individuality. With the flexibility to design and share content, there is a potential for users to upload avatar bodies and/or assets that may include unauthorized or inappropriate content. This presents a challenge for platform operators to enforce content policies and ensure that uploaded content complies with guidelines that maintain a safe and respectful virtual experience.

Existing content moderation systems on virtual platforms rely on a combination of automated tools and manual review. Automated tools, such as text and image filters, are often limited to detecting specific words or image patterns that may indicate a violation of platform policies. Such tools struggle when applied to complex 3D avatar bodies, which combine meshes, textures, and potentially a variety of accessories. The visual and structural complexity of 3D assets makes it challenging to accurately determine whether a given avatar body includes prohibited content, such as symbols, textures, or accessories that violate platform guidelines.

Some platforms use machine learning models trained to recognize specific features within images or 3D models to streamline moderation. While the models can be effective for some types of content, models require extensive labeled training data that includes a wide variety of policy-violating and non-violating content. This can be particularly challenging in environments where users are continually generating new and diverse assets that were not part of the original training dataset. As a result, the models may produce inaccurate results or fail to identify violations, necessitating significant manual intervention and adjustment.

The reliance on manual moderation presents scalability issues, as human reviewers may struggle to keep up with the volume of user-generated content submitted to popular platforms. Additionally, manual review can be subjective and inconsistent, potentially leading to errors or biases in enforcement.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, systems, and computer-readable media to detect policy-violating content in user-generated avatar bodies on a virtual platform using a multimodal machine-learned model that analyzes both visual and text inputs.

According to one aspect, a computer-implemented method includes obtaining a user-generated avatar body on a virtual platform, where the user-generated avatar body includes a 3D mesh and texture. The method further includes providing the user-generated avatar body and a set of text questions to a multimodal machine-learned model, where each text question relates to a characteristic associated with avatar bodies on the virtual platform. The method further includes obtaining a respective probability value associated with each of the text questions is obtained as output of the multimodal machine-learned model, where the respective probability indicates whether the user-generated avatar body possesses the characteristic. The method further includes determining, based on the probability values and using a decision model, whether the user-generated avatar body is violative of content policy of the virtual platform. The method further includes controlling usage of the user-generated avatar body on the virtual platform based on the determination of whether the user-generated avatar body is violative of content policy.

In some implementations, providing the user-generated avatar body to the multimodal machine-learned model includes generating one or more images of the user-generated avatar body that depict the user-generated avatar body in respective poses, and providing the one or more images of the user-generated avatar body to the multimodal machine-learned model.

In some implementations, the virtual platform includes a set of accessories attachable to the avatar bodies on the virtual platform, and wherein the characteristic is based on an attribute of at least one of the set of accessories.

In some implementations, the computer-implemented method further includes retrieving a set of tags, each tag corresponding to a respective attribute associated with at least one of the set of accessories; and generating, using a large language model (LLM) and based on the plurality of tags, one or more of the set of text questions.

In some implementations, the computer-implemented method further includes generating one or more of the set of tags by automatically analyzing the accessories available on the virtual platform, wherein the accessories are user-generated virtual assets, and wherein the analyzing comprises determining respective attributes associated with the virtual assets.

In some implementations, the respective attributes associated with the virtual assets relate to one or more of an accessory type, a body part that the accessory attaches to, a color of the accessory, a shape of the accessory, and any combination thereof.

In some implementations, the set of text questions are questions that are associated with an answer in the form of a yes or a no.

In some implementations, the computer-implemented method further includes generating one or more of the set of text questions using a LLM, wherein the content policy of the virtual platform is provided as input to the LLM.

In some implementations, controlling usage of the user-generated avatar body on the virtual platform includes, in response to determination that the user-generated avatar body is violative of content policy, blocking the user-generated avatar body from being available on the virtual platform or flagging the user-generated avatar body for manual review.

In some implementations, controlling usage of the user-generated avatar body on the virtual platform includes, in response to determination that the user-generated avatar body is not violative of content policy, making the user-generated avatar body available for use on the virtual platform.

In some implementations, the decision model is a logistic regression model, a tree-based model, a XGBoost model, or any combination thereof.

In some implementations, the decision model is a logistic regression model, and determining whether the user-generated avatar body is violative of content policy of the virtual platform is based on a weighted combination of the probability values.

In some implementations, the multimodal machine-learned model is a vision-language model pretrained to analyze visual and text input.

In some implementations, the computer-implemented method further includes training the multimodal machine-learned model based on a dataset of training avatar bodies that includes policy-violating training bodies and non-policy-violating training bodies.

According to another aspect, a system includes one or more processors and memory coupled to the one or more processors storing instructions that, when executed by the one or more processors, cause the one or more processors to perform operations including obtaining a user-generated avatar body on a virtual platform, where the user-generated avatar body includes a 3D mesh and texture. The operations further include providing the user-generated avatar body and a set of text questions to a multimodal machine-learned model, where each text question relates to a characteristic associated with avatar bodies on the virtual platform. The operations further include obtaining a respective probability value associated with each of the text questions as output of the multimodal machine-learned model, where the respective probability indicates whether the user-generated avatar body possesses the characteristic. The operations further include determining, based on the probability values and using a decision model, whether the user-generated avatar body is violative of content policy of the virtual platform. The operations further include controlling usage of the user-generated avatar body on the virtual platform based on the determination of whether the user-generated avatar body is violative of content policy.

In some implementations, providing the user-generated avatar body to the multimodal machine-learned model includes generating one or more images of the user-generated avatar body that depict the user-generated avatar body in respective poses, and providing the one or more images of the user-generated avatar body to the multimodal machine-learned model.

In some implementations, the virtual platform includes a set of accessories attachable to the avatar bodies on the virtual platform, and the characteristic is based on an attribute of at least one of the set of accessories. In some implementations, the instructions cause the one or more processors to perform further operations including: retrieving a set of tags, each tag corresponding to a respective attribute associated with at least one of the set of accessories; and generating, using an LLM and based on the set of tags, one or more of the set of text questions.

In some implementations, the instructions cause the one or more processors to perform further operations including generating one or more of the set of tags by automatically analyzing the accessories available on the virtual platform, wherein the accessories are user-generated virtual assets, and wherein the analyzing includes determining respective attributes associated with the virtual assets.

According to another aspect, a non-transitory computer-readable medium with instructions stored thereon is provided that, when executed by a processor, cause the processor to perform operations. The operations include obtaining a user-generated avatar body on a virtual platform, where the user-generated avatar body includes a 3D mesh and texture. The operations further include providing the user-generated avatar body and a set of text questions to a multimodal machine-learned model, where each text question relates to a characteristic associated with avatar bodies on the virtual platform. The operations further include obtaining a respective probability value associated with each of the text questions as output of the multimodal machine-learned model, where the respective probability indicates whether the user-generated avatar body possesses the characteristic. The operations further include determining, based on the probability values and using a decision model, whether the user-generated avatar body is violative of content policy of the virtual platform. The operations further include controlling usage of the user-generated avatar body on the virtual platform based on the determination of whether the user-generated avatar body is violative of content policy.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF DRAWINGS

FIG. 1 is a diagram of an example system architecture, in accordance with some implementations.

FIG. 2 is a flow diagram illustrating an example method to perform base body detection within a virtual platform, in accordance with some implementations.

FIG. 3A is a diagram illustrating an example of various base bodies uploaded to an avatar marketplace within a virtual platform.

FIG. 3B is a diagram illustrating another example of various base bodies constituting an augmented dataset of base bodies within a virtual platform.

FIG. 3C is a diagram illustrating an example of base bodies uploaded to an avatar marketplace on a virtual platform that violate the platform base body content policies.

FIG. 3D is a diagram illustrating an example of base bodies uploaded to an avatar marketplace on a virtual platform that are borderline acceptable under the base body content policies of the platform but are still deemed violative.

FIG. 4 is a diagram illustrating a set of tags identified for use in content moderation on a virtual platform.

FIG. 5 is a diagram illustrating example prompts generated for each tag which are used to identify policy-relevant attributes in user-generated avatar bodies on a virtual platform.

FIG. 6 is a block diagram that illustrates an example computing device, in accordance with some implementations.

### DETAILED DESCRIPTION

In the following detailed description, reference is made to the accompanying drawings, which form a part hereof. In the drawings, similar symbols may identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

One or more implementations described herein relate to performing base body detection in a virtual platform. Automated detection of unauthorized content in user-generated avatar bodies is performed by using a multimodal machine-learned model to analyze both visual and textual information. A user-generated avatar body is obtained on the virtual platform, where the avatar body includes a 3D mesh and texture. The avatar body is provided, along with a set of text questions related to characteristics of avatar bodies, to a multimodal model, such as a vision-language model, trained to analyze both image and text data in a common vector space.

For each text question, the multimodal model generates a probability value that indicates the likelihood of the avatar body possessing the characteristic associated with the question. The probability values provide insight into whether the avatar body includes features that may violate the content policies of the virtual platform. The probabilities are evaluated using a decision model, such as, e.g., a logistic regression model or a decision tree, to determine if the avatar body violates content policies based on the set of probability values.

Based on the determination of the decision model, the usage of the avatar body is controlled on the virtual platform. If the decision model indicates that the avatar body is non-compliant with content policies, the usage is restricted by either blocking the avatar body from being used on the platform or flagging it for manual review. If the decision model finds the avatar body compliant, it may be permitted for general use on the platform.

Some technical advantages of one or more described features include improved scalability in content moderation for user-generated avatar bodies within virtual platforms. By automating the detection of policy-violating content, the need for extensive manual review is reduced, enabling the platform to process large volumes of user-generated content quickly and efficiently. The automated approach is especially beneficial for virtual platforms and virtual experiences within such platforms where users constantly create and share new assets, including avatar bodies and accessories, which otherwise require significant resources to review manually. By using machine learning models that analyze both visual and textual data, high throughput of user-generated content can be enabled while ensuring compliance with platform policies, and with a high degree of accuracy.

Another technical advantage of some implementations is the flexibility offered by the decision model, which can be adapted to various types of policy violations. The decision model, which may include a logistic regression model, decision tree, or similar technique, evaluates the probability values generated by the multimodal model to determine if an avatar body is non-compliant with platform policies. The platform can adjust enforcement criteria by configuring thresholds or weights for different types of characteristics. For example, detecting some types of violations, such as offensive symbols, can be prioritized over detecting other types of violations by adjusting parameters of the decision model, making moderation more responsive to the evolving needs of the platform.

Another technical advantage of some implementations is modularity, which allows for seamless updates and integration of new technologies. The use of an LLM to generate text questions and a multimodal vision-language model to analyze both images and text in a shared vector space enables high adaptability. As new assets, tags, or policy requirements emerge on the platform, the LLM can dynamically generate updated questions, and the decision model can incorporate the changes without requiring retraining of the entire system. The modularity enhances the longevity of the system and reduces maintenance complexity, ensuring the platform can continually adapt to new content types and policy adjustments.

Another technical advantage of some implementations is enhanced accuracy in detecting unauthorized content by employing a multimodal approach that combines visual and textual data. The vision-language model is trained to map images and text into a shared vector space, enabling it to recognize complex visual features in context with descriptive characteristics. The multimodal capability enables detection of nuanced policy violations that would be challenging to identify using traditional image recognition models alone. For example, some accessories or textures that might appear benign in isolation can be identified as policy-violating when analyzed in conjunction with specific descriptive tags.

Another technical advantage of some implementations is the ability to control the usage of avatar bodies based on content compliance determinations made by the decision model. By automating restriction, the platform can immediately block or flag avatar bodies that are identified as violating content policies, ensuring that non-compliant content is handled before it reaches the broader user base.

Another technical advantage of some implementations is in providing a robust and adaptable foundation for content moderation in dynamic virtual platforms. The modular architecture enables components—e.g., the LLM, the vision-language model, and the decision model—to be updated or replaced independently as new advancements in machine learning become available.

### System Architecture

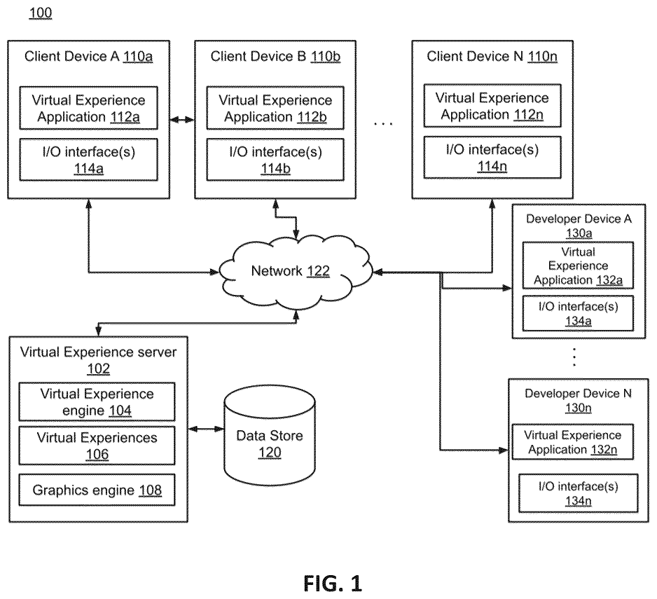

FIG. 1 is a diagram of an example system architecture that can be used for tracking body movements of players without user-perceptible lag using a single camera feed on devices that may have limited computational processing power. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” may include any or all of the elements in the figures bearing that reference numeral (e.g. “110” in the text may include reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

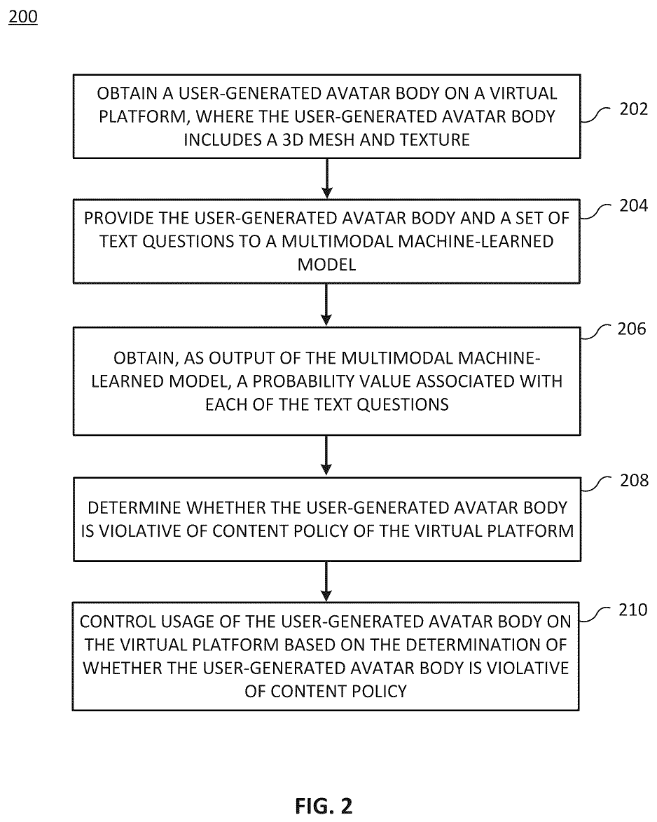

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowchart shown in FIG. 2. In one or more additional or alternative implementations, the operations described below may be performed on one or more client devices 110, or one or more developer devices 130. In some implementations, where the operations are performed depends at least in part on computational resources, e.g., memory, processing power, or disk space. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. Other implementations of the disclosure include a “user” (e.g., creating user) being an entity controlled by a set of users or an automated source. For example, a set of individual users federated as a community or group in a user-generated content system may be considered a “user.”

In some implementations, online virtual experience server 102 may be or include a virtual gaming server. For example, the gaming server may provide single-player or multiplayer games to a community of users that may access a “system” herein that includes online virtual experience server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in near-real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For example, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (i.e., avatar) of the user within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, virtual experience engine 104 or virtual experience application 112 may perform various techniques of copy detection described herein. For example, virtual experience engine 104 may generate 3D meshes of user-generated outfits equipped by avatars within the virtual platform. The virtual experience engine 104 may replace the avatar of the user with a standardized virtual mannequin and equip the user-generated outfit onto the mannequin. Virtual experience application 112 may compute sub-meshes for each body part of the virtual mannequin and generate corresponding HoG embeddings. The embeddings may be hashed using a hash function and compared to reference embeddings stored in a nearest-neighbor index, with the results used to identify potential copies of rare or high-value virtual assets.

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to facilitate an interaction of the user with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may control the scale (e.g., height, width, or depth) of a character or the scale of components of a character. In some implementations, the user may control the proportions of a character (e.g., blocky, anatomical, etc.). In some implementations, a character may not include a character virtual experience object (e.g., body parts, etc.) but the user may control the character (without the character virtual experience object) to facilitate the interaction of the user with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a character of a user for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, animate or inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a character of a user can include a configuration of components, where the configuration and appearance of components and more generally the appearance of the character may be defined by character settings. In some implementations, the character settings of a character of a user may at least in part be chosen by the user. In other implementations, a user may choose a character with default character settings or character setting chosen by other users. For example, a user may choose a default character from a character catalog that has predefined character settings, and the user may customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with credentials, a virtual experience developer may obtain access to virtual experience virtual objects, such as in-platform currency (e.g., virtual currency), avatars, special powers, or accessories, which are owned by or associated with other users.

In general, functions described in one implementation as being performed by the online virtual experience server 102 can be performed by the client device(s) 110, or a server, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

### Base Body Detection in a Virtual Platform

FIG. 2 is a flow diagram illustrating an example method 200 to perform base body detection in a virtual platform, in accordance with some implementations. In various implementations, the blocks shown in FIG. 2 and described below may be performed by any of the elements illustrated in FIG. 1, e.g., one or more of client devices 110 and/or online virtual experience server 102. For example, in a distributed simulation, two or more client devices 110 may perform method 200, or at least one client device 110 and online virtual experience server 102 may perform method 200. In some implementations, some blocks of method 200 may be performed by a client device 110 and other blocks of method 200 may be performed by an online virtual experience server 102. Method 200 begins at block 202.

At block 202, a user-generated avatar body is obtained on a virtual platform, where the user-generated avatar body includes a three-dimensional (3D) mesh and texture. A virtual platform may include an online environment that supports user interaction through digital representations, enabling users to engage in various activities within virtual experiences, such as socializing, gaming, and digital asset creation. Examples of virtual platforms include online multiplayer games, social VR (virtual reality) environments, and metaverse applications. Within the virtual platform, users can create, customize, and interact with digital representations of themselves or other characters, known as avatars. The avatars are the primary means by which users experience and interact with the virtual experience and other users.

A user-generated avatar body includes the visual and structural components that form the base appearance of an avatar within the virtual platform. The avatar body is defined by a 3D mesh, which is a geometric data structure composed of vertices, edges, and faces arranged in 3D space to outline the shape of the avatar. For example, a humanoid avatar body might have a mesh with vertices forming the basic contours of a human figure, including limbs, torso, and head. The mesh defines the spatial form of the avatar but does not specify its surface appearance. The surface appearance is provided by a texture, which is a two-dimensional (2D) image applied to the mesh to impart color, patterns, and fine details, such as skin tone, facial features, or clothing patterns. Together, the mesh and texture produce a complete, visually recognizable avatar body when rendered in the virtual platform.

The user-generated avatar body may serve as a base for additional virtual assets or accessories, which are digital items that can be attached or applied to avatars. Virtual assets include clothing, hats, glasses, jewelry, and other items that modify the appearance of the avatar. The assets can be created by users and are distributed or sold within the marketplace of the virtual platform. A user-generated outfit may include an avatar body that includes one or more of the virtual assets, altering the base appearance to reflect the customization choices of the user. Virtual assets may include functional or thematic items that transform an appearance of an avatar, such as armor in a fantasy game or a spacesuit in a science-fiction setting.

In some implementations, obtaining a user-generated avatar body on a virtual platform may involve the 3D mesh and associated texture data being retrieved from a storage location, such as a platform database, where user-created or previously purchased assets are stored. The obtaining can occur in response to customization actions of the user or the submission of a new avatar body design to the platform. When retrieved, the avatar body data is prepared for further processing, which may involve generating images or analyzing characteristics of the avatar. For example, the platform may create multiple images of the avatar body in different poses to capture various views of its 3D structure and associated textures. The images serve as the input for subsequent content analysis operations, such as determining whether the avatar body complies with predefined content policies on the platform. Block 202 is followed by block 204.

At block 204, the user-generated avatar body and a set of text questions are provided to a multimodal machine-learned model, where each text question relates to a characteristic associated with avatar bodies on the virtual platform. The multimodal machine-learned model is a type of model capable of processing both visual and text inputs in a shared vector space, enabling analysis of complex relationships between images and descriptive text. By receiving the avatar body in image form alongside text-based questions, the model can be used to determine whether one or more characteristics are present within the avatar body based on how well the visual features align with the descriptive content in each text question.

The set of text questions is generated based on characteristics associated with avatar bodies on the virtual platform. In various implementations, the characteristics may include various attributes, such as the type of accessory applied to the avatar body, colors, textures, or any other features that are relevant to the content policies of the platform. For example, a text question might ask whether the avatar body has any headwear, specific colors, or identifiable symbols. Each text question is designed to prompt the model to identify the likelihood that a given feature exists within the visual representation of the avatar body.

In some implementations, the multimodal machine-learned model converts each text question and the image of the avatar body into embeddings within the same vector space. Embeddings are mathematical representations of data that enable the model to measure the similarity between different inputs. By mapping both visual and textual information into a shared space, the model can compute the relationship between each text question and the visual content of the avatar body.

In some implementations, providing the user-generated avatar body to the multimodal machine-learned model includes generating one or more images of the avatar body in various poses. An avatar body within the virtual platform includes a 3D mesh and texture that define its structure and appearance. To analyze the avatar body using the multimodal machine-learned model, which processes visual data in image format, the 3D representation of the avatar body is rendered into one or more images. Each image generated captures the avatar body from a specific viewpoint or in a particular pose, which enables the model to determine different visual features of the body across multiple perspectives.

Generating images in various poses provides additional viewpoints that reveal different aspects of the appearance of the avatar body, such as the orientation and spatial arrangement of attached virtual assets. Virtual assets, including clothing, accessories, or other items attached to the avatar body, may change appearance when viewed from different angles or under varying lighting conditions. For example, headwear on an avatar may appear differently when the avatar is rendered facing forward versus when rendered in a side view. Multiple images in diverse poses enable the multimodal machine-learned model to perform evaluation of the avatar body in a more accurate fashion. Once the images are generated, they are provided to the multimodal machine-learned model as input for analysis. The multimodal model is configured to interpret each image and map its visual features into a shared vector space where they can be compared against text-based embeddings of descriptive characteristics, such as those related to content policy restrictions. By receiving multiple images, the model can analyze different views of the avatar body, which may reveal details that are not visible from a single perspective.

In some implementations, rendering and providing multiple images of the avatar body in different poses may involve adjustments in rendering parameters within the virtual platform, such as, e.g., camera angle, distance, and lighting. The platform may render the avatar body from standard poses that highlight commonly evaluated attributes, or from platform-specific poses that reflect typical user interactions within virtual experiences. For example, poses may include a front view, side view, or back view to capture different sides of the avatar body, or poses where the avatar body is seated or in motion to better evaluate how some virtual assets appear in realistic scenarios.

In some implementations, the virtual platform includes a set of accessories that can be attached to avatar bodies, and the characteristic being evaluated in the content moderation is based on an attribute of at least one of the accessories. Accessories in this context refer to user-generated or platform-provided digital items designed to modify or enhance the appearance of avatar bodies. The accessories may include items such as hats, glasses, clothing, footwear, or thematic props that users can add to their avatars to personalize them. Each accessory has specific attributes, which may include properties like color, size, shape, attachment location on the avatar body, and material texture.

Attributes of accessories are key factors in determining compliance with platform content policy. For example, some types of accessories, such as headwear with specific shapes or symbols, may be subject to content restrictions due to cultural, ethical, or safety guidelines established by the platform. The characteristic being determined in the content moderation may be based on the attributes to ensure compliance. For example, a characteristic may relate to whether an avatar body includes accessories with particular shapes or symbols that may signify restricted content.

The multimodal machine-learned model evaluates the presence of characteristics related to accessory attributes by analyzing visual and textual data. Each accessory attribute that may be subject to content policy restrictions can be represented as a text question, which the model uses to determine the probability of that characteristic being present in the avatar body. For example, if the content policy restricts accessories with specific colors or logos, the model may include text questions related to the attributes. A comparison of the visual features of the avatar body represented by an image embedding with the text embeddings of the accessory-related characteristics, enables determination of the likelihood that the avatar possesses a restricted attribute.

In some implementations, a set of tags are received, each tag associated with a respective attribute of at least one of the accessories available on the virtual platform. Tags represent descriptive metadata that provide information about various attributes of an accessory, such as type, color, shape, material, or attachment location on the avatar body. For example, a tag might indicate that an accessory is a “hat,” is “red,” or “attaches to the head” of the avatar. The tags serve as structured labels that enable cataloging and retrieval of accessory attributes in a way that supports content moderation.

The tags retrieved for each accessory attribute are used as input to a large language model (LLM), which generates a set of text questions based on the tags. An LLM is an artificial intelligence model trained on extensive natural language data, enabling it to generate coherent text or extract patterns from given inputs. In this case, the LLM receives the accessory tags as input and produces binary text questions corresponding to each attribute, framing them in a yes-or-no format. For example, if an accessory tag indicates “black hat,” the LLM might generate questions such as “Does the avatar body include a black hat?” or “Is there headwear on the avatar in the color black?”

By generating the text questions, the LLM transforms the raw tag data into queryable characteristics that can be processed by the multimodal machine-learned model. The questions serve as a bridge between the tag-based attributes of accessories and the evaluation of the avatar body. Each question is designed to determine whether the avatar possesses specific characteristics that align with content policy requirements.

In some implementations, one or more of the tags used for content moderation are generated by automatically analyzing the accessories available on the virtual platform, where the accessories are user-generated virtual assets. Analyzing accessories to generate tags includes assessing each virtual asset to identify its attributes systematically. For example, an accessory such as a hat may be analyzed to determine attributes like color (e.g., red), type (e.g., headwear), and shape (e.g., circular). The attributes are converted into tags that can be used to label and categorize the accessory.

The analysis may involve techniques from, e.g., computer vision, machine learning, or predefined rules that map visual or structural features of the asset to corresponding tags. Automated analysis of the virtual assets enables assignment of consistent and relevant tags to a wide array of user-generated content, creating a structured representation of attributes of each accessory. The generated tags serve as metadata that describe the accessory attributes in a standardized format. By converting attributes into tags, the platform can store, retrieve, and evaluate accessory data in a structured manner that aligns with content policy requirements. For example, if a particular accessory has attributes that may be restricted by the content policy of the virtual platform, such as a specific symbol or design, the characteristics can be tagged accordingly. Tags generated from automated analysis thus enable the platform to maintain a comprehensive database of accessory attributes, enabling more accurate content evaluations. The tags are used to produce text questions through an LLM to enable evaluation by the multimodal machine-learned model.

In some implementations, the respective attributes associated with the virtual assets are defined in terms of one or more specific characteristics, including accessory type, body part that the accessory attaches to, color of the accessory, shape of the accessory, or any combination thereof. Accessory type may include the classification of the virtual asset based on its function or category within the virtual platform. Examples of accessory types may include, e.g., clothing, equipment, vehicles, instruments, and weapons. Other examples of accessory types may include, e.g., jewelry, jackets, shoes, shoes, jeans, chains, shorts, suits, armor, pajamas, lipstick, pants, headsets, watches, watches, bags, dresses, tattoos, piercings, gloves, and mittens. By identifying a type of an accessory, the accessory can be tagged according to its functional role within the avatar customization options.

The body part that the accessory attaches to may be another attribute used to categorize virtual assets. The attribute specifies the intended placement of the accessory on the avatar body, such as the head, torso, arms, or legs. For example, a hat would be associated with the head, while shoes would be associated with the feet. The attachment location is utilized for defining the spatial relationship between the accessory and the avatar body, which can influence the evaluation of content policy compliance. Some content policies may apply only to accessories that attach to particular body parts, making the attribute crucial for accurate content moderation.

In some implementations, color of the accessory may be included as an attribute. Color attributes provide information about the primary colors or color patterns present on an accessory, which may be relevant for identifying items that meet specific content guidelines. For example, some colors may be restricted for use in particular contexts, or combinations of colors may indicate associations with specific themes or symbols. By tagging accessories with their color information, color-based characteristics can be analyzed as part of content moderation.

In some implementations, shape of the accessory may be included as an attribute. Shape may include the general form or geometry of the accessory, such as circular, rectangular, or angular forms, which may relate to platform policies regarding specific visual elements. Some shapes may be regulated by content policy if they resemble restricted symbols or themes. Shape attributes can be utilized, in combination with other tags, to create a comprehensive representation of characteristics of the accessory, enabling an in-depth analysis of policy compliance. By combining attributes such as type, attachment location, color, and shape, a tagging structure can be generated that enables nuanced content moderation based on a diverse set of criteria relevant to the virtual platform.

In some implementations, the set of text questions generated are associated with answers in the form of a yes or a no. The binary nature of the text questions simplifies the input requirements for the multimodal machine-learned model. Each question corresponds to a specific attribute or characteristic of the avatar body or attached accessories, such as “Does the avatar body have headwear?” or “Is there a red accessory present on the avatar body?” The questions enable a focus on distinct features that may or may not align with content guidelines of the virtual platform, translating complex attribute-based information into clear, binary queries.

The yes-or-no format of the questions enables the multimodal machine-learned model to produce probability values indicating the likelihood of each characteristic being present, rather than needing to interpret or analyze open-ended responses. For example, if a text question asks, “Is there headwear on the avatar body?” the model will output a probability value that reflects the confidence level regarding the presence of headwear. The use of yes-or-no questions enables consistent interpretation of content policy guidelines, as each question directly aligns with specific criteria defined by the platform. Each probability value generated in response to the binary questions can be fed into the decision model, which uses them to determine compliance with content policy.

In some implementations, one or more of the set of text questions are generated using an LLM, with the content policy of the virtual platform provided as input to the LLM. In this context, the LLM uses the content policy of the virtual platform as guidance to create questions that align with specific criteria and restrictions outlined in the policy. By providing the content policy as input, the LLM is able to produce text questions that are tailored to detect policy-violating attributes within user-generated avatar bodies and accessories. For example, if the content policy restricts some symbols, colors, or types of accessories, the LLM generates questions targeting the prohibited characteristics. Questions might include, “Does the avatar body display any restricted symbols?” or “Is there an accessory in a restricted color?” The questions are designed to prompt the multimodal machine-learned model to identify whether the avatar body possesses attributes that may contravene the content guidelines of the virtual platform.

The ability of the LLM to generate questions based on content policy input enables adjusting to policy updates or changes dynamically. As content policies are modified to include new restrictions or remove outdated ones, the LLM can be prompted with the latest policy version to generate relevant questions that reflect the current moderation criteria.

The text questions generated by the LLM are subsequently processed by the multimodal machine-learned model alongside visual data of the avatar body. By structuring the questions based on content policy criteria, a wide range of potential violations across various features and attributes of avatar bodies and attached accessories can be detected.

In some implementations, the multimodal machine-learned model utilized in the content moderation is a vision-language model pretrained to analyze both visual and text input. A vision-language model is a type of machine learning model trained on large datasets that include both images and descriptive text, enabling it to interpret relationships between visual and textual information. The model operates in a common vector space, where embeddings for both images and text are generated in a way that aligns similar concepts across modalities. For example, an image of an avatar body wearing a hat may generate a similar embedding to the text input “avatar with headwear,” enabling the model to determine the likelihood of the avatar possessing specific attributes based on both visual and textual input.

In the context of the virtual platform, the vision-language model processes an image of the user-generated avatar body alongside a set of text-based questions that correspond to characteristics or attributes relevant to content policy. Each text question describes a particular feature or aspect that may be regulated by the guidelines of the virtual platform, such as the presence of specific accessories, colors, or symbols. The vision-language model generates embeddings for both the image of the avatar body and each text question, comparing them within the shared vector space. The comparison enables the model to calculate similarity or probability values indicating whether each queried characteristic is likely present in the avatar body.

The pretraining of the vision-language model enables it to recognize a wide range of visual features and associate them with descriptive text inputs, even in cases where specific examples were not present in the training data. For example, the model can generalize from its training data to identify similar shapes, textures, or patterns that align with restricted content, even if those specific representations are unique to the virtual platform.

In some implementations, the vision-language model is further trained on a dataset of avatar bodies that includes both policy-violating and non-policy-violating examples. The training aims to refine the ability of the model to distinguish between avatar bodies that comply with content policy and those that do not. The dataset comprises images of avatar bodies annotated with labels indicating whether each body aligns with platform content guidelines, enabling the model to be trained on patterns associated with compliance and violation scenarios.

In some implementations, the dataset of training avatar bodies includes various examples of policy-violating features, such as restricted symbols, prohibited color schemes, or specific accessory types that may be subject to moderation. Each policy-violating avatar body in the dataset is labeled to highlight the relevant attributes that contribute to the violation, enabling the vision-language model to associate the characteristics with non-compliance. Similarly, the dataset contains non-policy-violating avatar bodies that exhibit permissible features, helping the model understand the characteristics of compliant avatar bodies.

During training, the model is presented with both visual inputs (images of avatar bodies) and corresponding text-based characteristics derived from the content guidelines of the virtual platform. The training includes adjusting the weights of the model to minimize the error in its classification of each training example, aligning the embeddings of policy-violating avatars with their associated characteristics while maintaining clear separation from non-violating avatars. As a result, the model becomes better equipped to calculate accurate probability values that reflect the likelihood of specific attributes aligning with content policy restrictions when it processes real-world avatar bodies on the platform. Block 204 is followed by block 206.

At block 206, a respective probability value associated with each of the text questions is obtained as output of the multimodal machine-learned model, where the respective probability indicates whether the user-generated avatar body possesses the characteristic. Each probability value represents the likelihood that the characteristic described by the corresponding text question is present in the user-generated avatar body. The probability values serve as quantitative indicators, enabling assessment of each feature with a degree of confidence rather than a binary outcome.

The multimodal machine-learned model calculates the probability values by evaluating the similarity between the image embedding of the avatar body and the text embeddings of the questions, all within a shared vector space. The resulting probabilities reflect the alignment between the visual features of the avatar body and each characteristic in question. For example, if a text question pertains to the presence of headwear, a high probability value would indicate a strong likelihood that headwear is indeed present in the avatar body, whereas a low probability would suggest its absence.

Each probability value indicates the likelihood that the avatar body possesses the characteristic specified by the corresponding question. By generating a set of probability values across multiple questions, the model evaluates features of the avatar body in relation to platform content guidelines. The evaluation includes the likelihoods of various characteristics that may be regulated by the content policies of the virtual platform, such as specific accessories, symbols, or colors that may signify a policy violation. Block 206 is followed by block 208.

At block 208, a determination is made, based on the probability values and using a decision model, of whether the user-generated avatar body is violative of content policy of the virtual platform. The decision model, which may be a logistic regression model, a decision tree, or another machine learning model, takes the set of probability values generated for each characteristic-related question and processes them to arrive at a classification outcome. The classification outcome indicates whether the avatar body, as represented by the probability values, is compliant with or violative of the content policy of the platform.

In various implementations, the decision model uses predefined thresholds or criteria to evaluate whether the avatar body violates content policy based on the probability values. For example, the model may determine that an avatar body is violative if certain characteristics associated with restricted assets meet a given probability threshold. In some implementations that make use of a logistic regression model, each probability value may be assigned a specific weight that reflects its relative importance in the content policy. The weights, combined with the probability values, contribute to a final score that is compared against a threshold to classify the avatar body as compliant or non-compliant. In a decision tree model, the model may use conditional branches that evaluate combinations of probability values to classify the avatar body.

The determination enables the virtual platform to apply content policy standards to each avatar body before it is made available within the platform. In various implementations, content policies may restrict avatar appearances that include specific characteristics, such as, e.g., explicit symbols, inappropriate color patterns, copies of existing virtual assets, or combinations of assets deemed unsuitable for the environment of the platform.

In some implementations, the decision model used to evaluate whether the user-generated avatar body is compliant with content policy may be implemented as a logistic regression model, a tree-based model, an XGBoost model, or any combination thereof (e.g., including multiple models that form an ensemble). A decision model in this context is a machine learning or statistical model that processes the probability values associated with specific characteristics of the avatar body to make a classification decision. The classification decision determines whether the avatar body complies with or violates the content policy of the virtual platform based on the characteristics determined by the multimodal machine-learned model.

A logistic regression model is a statistical model commonly used for binary classification tasks. It evaluates input probability values by applying weights to each characteristic and combining them to generate a final score, which is mapped to a probability indicating compliance or non-compliance. Each characteristic determined by the multimodal machine-learned model is assigned a weight according to its relevance or importance in content policy evaluation. The logistic regression model calculates a combined score, which is compared against a predetermined threshold to classify the avatar body as either compliant or violative.

In some implementations, the determination of whether the user-generated avatar body violates the content policy of the virtual platform is based on a weighted combination of probability values associated with specific characteristics. Each probability value, representing the likelihood of the presence of a characteristic, is assigned a weight reflecting its importance within the content policy framework. The logistic regression model computes a weighted sum of the values, generating a single score that indicates overall policy compliance. The combined score is transformed into a probability, which is compared to a predetermined threshold to classify the avatar body as compliant or violative. Characteristics deemed more relevant to policy adherence may be assigned higher weights, while those less important have lower weights, enabling the model to be trained to prioritize certain factors in the compliance determination.

A tree-based model, such as a decision tree or random forest, classifies the avatar body based on a set of conditional decisions applied to the probability values. Each node in the tree represents a decision based on a probability value of a specific characteristic, with branches that split according to whether the value meets a defined criterion. For example, a decision node might determine if the probability of a certain characteristic meets a threshold, directing the model down a specific branch. The determination continues through multiple nodes until a terminal node is reached, which outputs the classification as either compliant or non-compliant with the content policy.

An XGBoost model, or eXtreme Gradient Boosting, is an advanced tree-based model that uses a set of decision trees in an ensemble approach, optimizing classification accuracy by learning from errors in previous trees. XGBoost applies gradient boosting to iteratively refine the classification, resulting in a robust model capable of handling complex relationships among characteristics. In implementations where multiple model types are combined, such as a hybrid of logistic regression and XGBoost, the decision model may utilize the strengths of each model type to achieve accurate content policy evaluation for user-generated avatar bodies on the platform.

Block 208 is followed by block 210.

At block 210, usage is controlled of the user-generated avatar body on the virtual platform based on the determination of whether the user-generated avatar body is violative of content policy. Usage control may include actions taken by the virtual platform to enforce content policy compliance by either allowing, restricting, or flagging the avatar body.

In various implementations, if the determination from the decision model indicates that the user-generated avatar body violates content policy, the platform may restrict its usage in one of several ways. For example, the avatar body may be blocked from appearing in virtual experiences across the platform, preventing it from being used in public or shared spaces. Alternatively, the avatar body may be flagged for manual review, enabling a human moderator to determine whether features of the body indeed violate policy requirements before taking further action.

If the avatar body is deemed compliant with content policy, it may be approved for unrestricted use across the virtual platform. Approval of compliant avatar bodies enables users to engage freely in virtual experiences, customizing their avatars with user-generated outfits or other virtual assets within the bounds of guidelines of the virtual platform. User-generated outfits refer to customized configurations of an avatar body that may include various virtual assets, such as clothing, accessories, or thematic items.

In some implementations, controlling usage of the user-generated avatar body on the virtual platform includes, in response to a determination that the avatar body violates content policy, either blocking the avatar body from being available on the virtual platform or flagging it for manual review. Blocking the avatar body from availability prevents it from being used or displayed within the virtual platform, effectively removing it from public or shared environments where other users may view or interact with it.

In addition to blocking, the avatar body may be flagged for manual review by platform moderators. Flagging the avatar body directs it to a queue for human examination, where moderators can determine the specific attributes or characteristics that triggered the violation determination. Manual review is used in cases where further analysis or judgment may be required to verify whether the avatar body indeed contravenes content policy guidelines. The manual review allows for a level of oversight in the moderation workflow, addressing cases that may be complex, ambiguous, or require interpretation beyond automation.

The decision to block or flag an avatar body for review may be based on specific thresholds or rules within the decision model that evaluates compliance of the avatar body. For example, the model may be configured to block avatar bodies that clearly violate certain high-priority policy elements, while avatar bodies with borderline or ambiguous features are flagged for further evaluation.

In some implementations, controlling usage of the user-generated avatar body on the virtual platform includes, in response to a determination that the avatar body is not violative of content policy, making the avatar body available for use on the platform. Once the avatar body is deemed compliant with the content policy of the virtual platform, it is permitted to be displayed and interacted with within the virtual experience. In some implementations, making the avatar body available for use includes updating its status within the virtual platform, allowing it to appear in designated areas such as user profiles, shared spaces, or specific virtual experiences offered by the platform.

Once the avatar body is made available on the platform, it may be accessible for further customization by the user, including the addition of accessories or modifications to appearance, as long as the adjustments remain within content policy guidelines. For example, users can add virtual assets like clothing or props to their approved avatar bodies to personalize them further. The avatar body is permitted to become an active part of the profile of the user and representation within the platform.

In some implementations, one or more of blocks 202-212 may be performed by one or more server devices, and one or more of blocks 202-212 may be performed by one or more client devices. In some implementations, all of method 200 may be performed by a server device, or by a client device. In some implementations, block 208 or block 210 may be omitted.

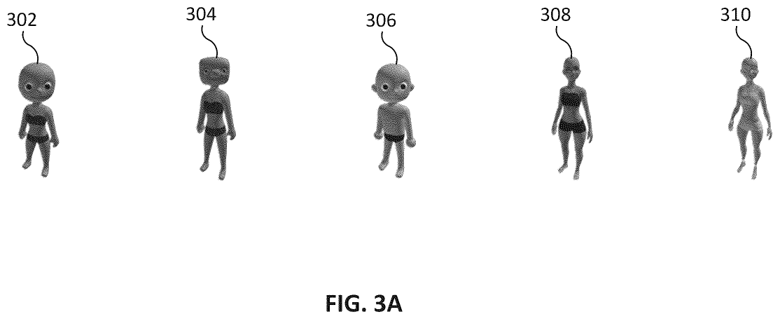

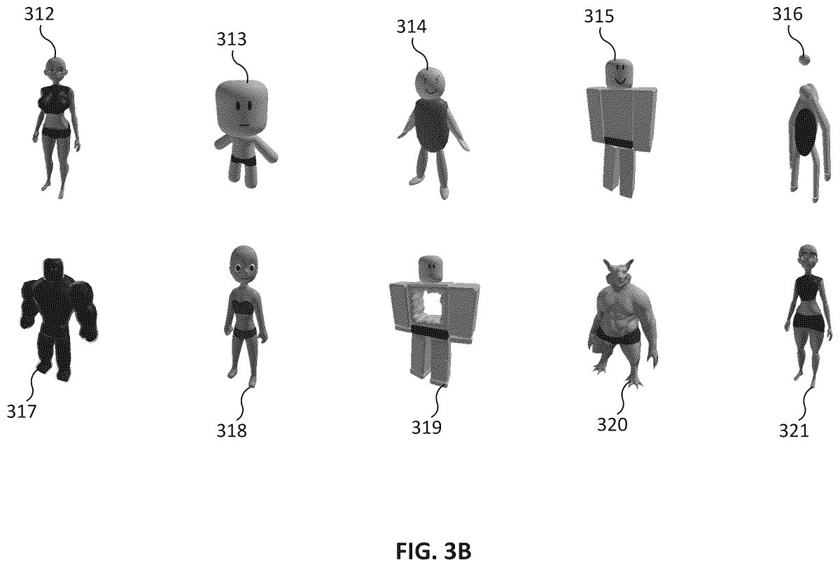

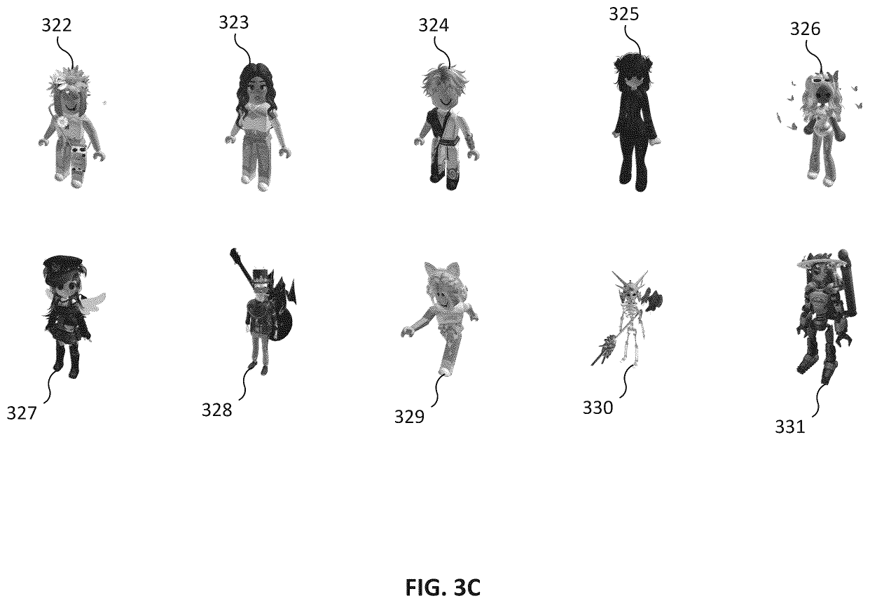

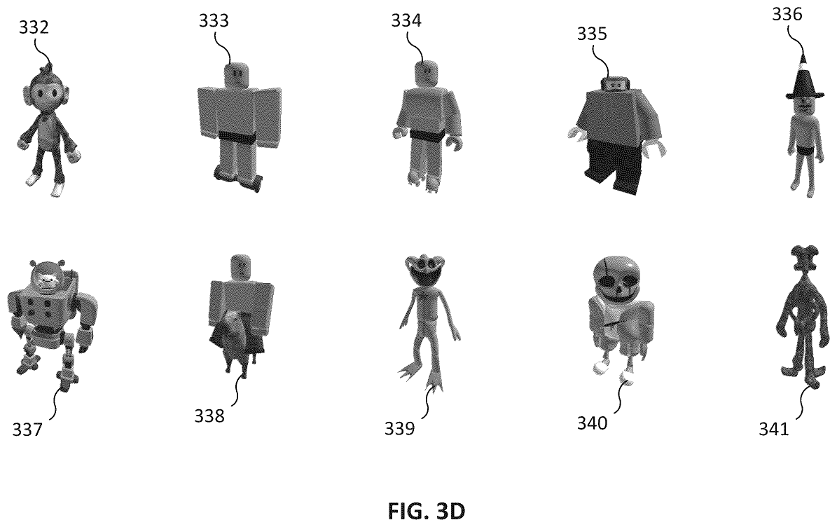

FIG. 3A is a diagram illustrating an example of various base bodies uploaded to an avatar marketplace within a virtual platform. The avatar marketplace is an online environment where users can browse, purchase, and apply different avatar bodies and accessories to personalize their virtual representation. Each base body depicted in the example represents a foundational avatar structure that users can further customize with clothing, accessories, and other virtual assets. The base bodies serve as starting points for user customization, providing a standardized template for further modification.

In FIG. 3A, the base bodies are represented by items 302, 304, 306, 308, and 310, each showing a unique avatar design or appearance within the marketplace. Each of the base bodies includes a 3D mesh structure and a basic texture, which collectively define the physical shape and visual appearance of the avatar at the foundational level. The base bodies do not include additional accessories, textures, or items, such as clothing or hats, and are displayed in a neutral state that users can later personalize. The base bodies in FIG. 3A provide examples of the types of avatars users may choose from to build their customized appearance on the platform.

FIG. 3B is a diagram illustrating an example of various base bodies constituting an augmented dataset of base bodies within a virtual platform. The dataset expansion includes adding various styles of hair and altering skin colors, generating a wider array of base body examples to enhance the training dataset used for model development. Augmenting the dataset in this manner increases the diversity of base bodies, supporting more comprehensive and representative training for content moderation and avatar recognition systems.

Each item, 312-321, represents a unique variation of a base body that has been modified from the original dataset. The base bodies incorporate differences in skin color, hair style, and overall appearance, reflecting a broader spectrum of potential user customization options on the virtual platform. By including the augmented variations, the training dataset is better equipped to handle a wide range of avatar appearances.

The augmentations applied to each base body include modifications that mimic common customization choices users might make within the platform, such as selecting different accessories, altering body shapes, or adding unique structural elements. For example, item 314 shows a base body with exaggerated proportions and stylized features, representing an artistic, cartoon-like interpretation of avatar design. Item 315 shows a base body with a block-like structure, featuring rigid geometric shapes that deviate from traditional humanoid forms. These augmentations expand the diversity of the dataset, enabling the model to recognize and analyze a wide range of structural and design variations when processing base bodies on the platform. By including such differences, the dataset supports robust generalization across various base body configurations, enhancing the system's ability to detect relevant characteristics during content moderation.

FIG. 3C is a diagram illustrating an example of base bodies uploaded to an avatar marketplace on a virtual platform that violate the platform base body content policies. The depicted base bodies exhibit characteristics or include virtual assets that contravene predefined guidelines for avatar design, such as, e.g., incorporating restricted accessories, inappropriate symbols, or unauthorized modifications. These examples are representative of the types of policy violations that the system aims to identify and manage through content moderation techniques.

The base bodies in FIG. 3C are represented by items 322-331, each illustrating distinct combinations of features or accessories that contribute to the content policy violations. These features may include, for example, oversized attachments, non-compliant textures, or prohibited themes. The violations vary in complexity, ranging from subtle rule breaches to overtly non-compliant designs. Each numbered item reflects a specific type of policy violation. For instance, some items may depict avatars with accessories resembling restricted symbols or oversized assets that alter the base body visual structure. Others might display unauthorized combinations of virtual assets, such as merging items that conflict with the platform customization rules.

FIG. 3D is a diagram illustrating an example of base bodies uploaded to an avatar marketplace on a virtual platform that are borderline acceptable under the base body content policies of the platform but are still deemed violative. These base bodies exhibit characteristics or features that closely align with the policy guidelines yet fail to meet the requirements fully. Such borderline cases present unique challenges in content moderation, as their violations are less overt and may require more nuanced analysis to identify.

The base bodies in FIG. 3D are represented by items 332-341. Each item highlights design choices that fall within ambiguous areas of the content policy, such as slightly exaggerated proportions, subtle unauthorized modifications, or borderline accessories that push the boundaries of acceptability. For example, some base bodies may incorporate minimal modifications to their structure or accessories that are difficult to classify as outright violations but still deviate from the intended design rules of the platform. Others may include borderline prohibited elements, such as minor stylistic deviations, partially concealed unauthorized assets, or design combinations that create ambiguity in interpretation.

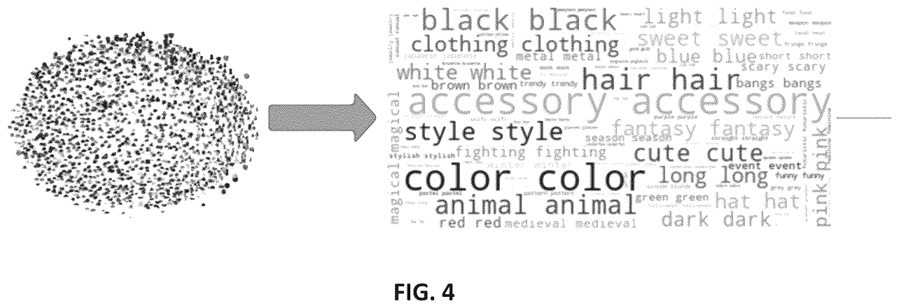

FIG. 4 is a diagram illustrating a set of tags identified for use in content moderation on a virtual platform. The tags are generated based on a comprehensive evaluation of items currently available in the avatar marketplace within the virtual platform. The tagging includes categorizing various attributes associated with avatar bodies and accessories to create a structured dataset that captures the range of customization elements users may apply. The tags serve as a foundation for detecting policy-violating content by representing specific characteristics of virtual assets that align with content policy requirements.

In FIG. 4, the tags are displayed in a word cloud format, where the size and prominence of each word correspond to its frequency or importance within the tagging system. Prominent tags such as “accessory,” “color,” “style,” “hair,” and “animal” indicate common attributes found across many items in the marketplace. The tags are derived from determinations of human evaluators and are designed to represent significant features of various assets on the platform. Each tag encapsulates a particular characteristic, enabling categorization of assets based on traits such as color (e.g., “black,” “pink”), style (e.g., “cute,” “fantasy”), and type (e.g., “clothing,” “accessory”).

The tags shown in the illustration are used to detect potential content policy violations, especially in cases where users may attempt to circumvent restrictions by applying subtle changes to their avatar bodies or accessories. For example, tags related to specific colors, themes, or accessory types provide the model with cues that can identify items attempting to imitate restricted or prohibited designs.

The arrow represents translating the tags into input for further analysis and enforcement actions. The tags are processed by an LLM, which uses the tags to generate descriptive questions or embeddings that aid in detecting policy violations across user-generated content.

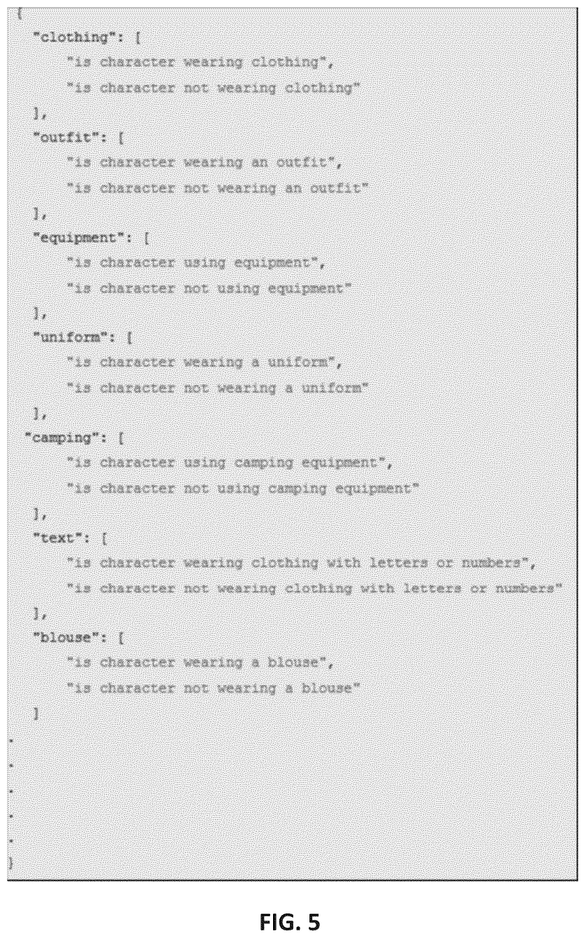

FIG. 5 is a diagram illustrating example prompts generated for each tag in a tagging system used to identify policy-relevant attributes in user-generated avatar bodies on a virtual platform. The prompts are designed to evaluate whether specific characteristics associated with each tag are present in the appearance of an avatar. An LLM is employed to generate the prompts, ensuring that the questions accurately capture the intended meaning of each tag. The prompts are structured to enable a binary response, which enables the model to determine the presence or absence of specific attributes by analyzing avatar images.

In the illustration, tags such as “clothing,” “outfit,” “equipment,” “uniform,” “camping,” “text,” and “blouse” are each associated with a set of prompts. For each tag, two prompts are generated: one that queries if the character is wearing or using something related to the tag, and another that queries if the character is not wearing or using that item. For instance, under the “clothing” tag, the prompts generated are “is character wearing clothing” and “is character not wearing clothing.” The binary prompts provide a way to evaluate the relevance of the tag to the avatar image. Other examples of prompts, e.g., single prompt for a tag, more than two prompts for a tag, etc. can also be used.

The use of an LLM enables prompt generation that adapts to the context of each tag. For example, the prompt for the “outfit” tag is generated as “is character wearing an outfit,” while the prompt for the “equipment” tag is “is character using equipment.” The prompts can accurately reflect the intended usage or appearance of each attribute on the virtual platform.

### Computing Device

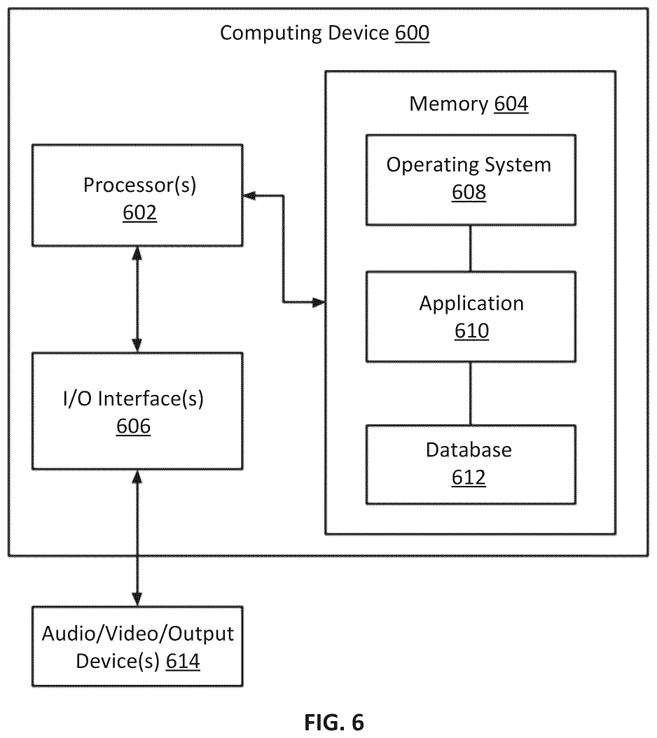

FIG. 6 is a block diagram of an example computing device 600 which may be used to implement one or more techniques described herein, including one or more techniques described with reference to FIG. 2, FIG. 3, and FIG. 4. In one example, device 600 may be used to implement a computer device (e.g., 102 and/or 110 of FIG. 1), and perform appropriate method implementations described herein. Computing device 600 can be any suitable computer system, server, or other electronic or hardware device. For example, the computing device 600 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 600 includes a processor 602, a memory 604, input/output (I/O) interface 606, and audio/video input/output devices 614.

Processor 602 can be one or more processors and/or processing circuits to execute program code and control basic operations of the device 600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “near-real-time”, “offline,” in a “batch mode,” etc. Portions of processing may be performed at different times and at different locations, by different (or the same) processing systems. A computer may be any processor in communication with a memory.

Memory 604 is provided in device 600 for access by the processor 602, and may be any suitable computer-readable or processor-readable storage medium, e.g., random access memory (RAM), read-only memory (ROM), Electrical Erasable Read-only Memory (EEPROM), Flash memory, etc., suitable for storing instructions for execution by the processor, and located separate from processor 602 and/or integrated therewith. Memory 604 can store software operating on the server device 600 by the processor 602, including an operating system 608, one or more applications 610, and a database 612 that may store data used by the components of device 600.

Database 612 may store datasets of avatar bodies and associated tags used for content moderation in a virtual platform, including base bodies, augmented bodies, and user-generated outfits annotated with tags related to accessory type, color, style, and other visual attributes pertinent to content policy. The database may contain policy-related tags and prompts generated by an LLM, enabling questioning related to avatar characteristics effectively. Additionally, the database may store parameters and training data for a vision-language model that creates embeddings of avatar images and text descriptions for similarity analysis within a shared vector space, enabling in-depth evaluation of avatar customization options. Applications 610 may include instructions for processor 602 to execute moderation functions, such as processing tags and prompts, generating probability values using the vision-language model, and applying a decision model to classify avatar compliance, ensuring content adherence in alignment with platform guidelines.

For example, applications 610 can include a module that implements one or more machine learning models used in the content moderation techniques described herein, such as a vision-language model and an LLM. Applications 610 may include mechanisms for generating embeddings of avatar images and text-based tags, enabling similarity analysis between visual and textual data within a shared vector space. The applications can integrate a decision model that processes probability values associated with specific avatar characteristics, determining content policy compliance based on the values. The applications may utilize prompts generated by the LLM to query avatar attributes relevant to content guidelines, with each prompt associated with a binary response for evaluating compliance. Database 612 (and/or other connected storage) can store data used in the moderation techniques, including tagged avatar bodies, user-generated outfits, prompts and tags for policy-relevant characteristics, model parameters, and probability values for detected characteristics.

Elements of software in memory 604 can alternatively be stored on any other suitable storage location or computer-readable medium. In addition, memory 604 (and/or other connected storage device(s)) can store instructions and data used in the features described herein. Memory 604 and any other type of storage (magnetic disk, optical disk, magnetic tape, or other tangible media) can be considered “storage” or “storage devices.”

I/O interface 606 can provide functions to enable interfacing the server device 600 with other systems and devices. For example, network communication devices, storage devices (e.g., memory and/or data store 120), and input/output devices can communicate via interface 606. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 614 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 6 shows one block for each of processor 602, memory 604, I/O interface 606, and software blocks of operating system 608 and virtual experience application 610. The blocks may represent one or more processors or processing circuitries, operating systems, memories, I/O interfaces, applications, and/or software engines. In other implementations, device 600 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform the operations described.

Device 600 can be a server device or client device. Example client devices or user devices can be computer devices including some similar components as the device 600, e.g., processor(s) 602, memory 604, and I/O interface 606. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 614, for example, can be connected to (or included in) the device 600 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 200 and other described techniques) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
obtaining a user-generated avatar body on a virtual platform, wherein the user-generated avatar body includes a 3D mesh and texture;
providing the user-generated avatar body and a plurality of text questions to a multimodal machine-learned model, wherein each text question relates to a characteristic associated with avatar bodies on the virtual platform;
obtaining, as output of the multimodal machine-learned model, a respective probability value associated with each of the text questions, wherein the respective probability value indicates whether the user-generated avatar body possesses the characteristic;
determining, based on the probability values and using a decision model, whether the user-generated avatar body is violative of content policy of the virtual platform; and
controlling usage of the user-generated avatar body on the virtual platform based on the determination of whether the user-generated avatar body is violative of content policy.

2. The computer-implemented method of claim 1, wherein providing the user-generated avatar body to the multimodal machine-learned model comprises:
generating one or more images of the user-generated avatar body that depict the user-generated avatar body in respective poses; and
providing the one or more images of the user-generated avatar body to the multimodal machine-learned model.

3. The computer-implemented method of claim 1, wherein the virtual platform includes a plurality of accessories attachable to the avatar bodies on the virtual platform, and wherein the characteristic is based on an attribute of at least one of the plurality of accessories.

4. The computer-implemented method of claim 3, further comprising:
retrieving a plurality of tags, each tag corresponding to a respective attribute associated with at least one of the plurality of accessories; and
generating, using a large language model (LLM) and based on the plurality of tags, one or more of the plurality of text questions.

5. The computer-implemented method of claim 4, further comprising generating one or more of the plurality of tags by automatically analyzing the accessories available on the virtual platform, wherein the accessories are user-generated virtual assets, and wherein the analyzing comprises determining respective attributes associated with the virtual assets.

6. The computer-implemented method of claim 5, wherein the respective attributes associated with the virtual assets relate to one or more of an accessory type, a body part that the accessory attaches to, a color of the accessory, a shape of the accessory, and any combination thereof.

7. The computer-implemented method of claim 4, wherein the plurality of text questions are questions that are associated with an answer in the form of a yes or a no.

8. The computer-implemented method of claim 1, further comprising generating one or more of the plurality of text questions using an LLM, wherein the content policy of the virtual platform is provided as input to the LLM.

9. The computer-implemented method of claim 1, wherein controlling usage of the user-generated avatar body on the virtual platform comprises, in response to determination that the user-generated avatar body is violative of content policy, blocking the user-generated avatar body from being available on the virtual platform or flagging the user-generated avatar body for manual review.

10. The computer-implemented method of claim 1, wherein controlling usage of the user-generated avatar body on the virtual platform comprises, in response to determination that the user-generated avatar body is not violative of content policy, making the user-generated avatar body available for use on the virtual platform.

11. The computer-implemented method of claim 1, wherein the decision model is a logistic regression model, a tree-based model, a XGBoost model, or any combination thereof.

12. The computer-implemented method of claim 11, wherein the decision model is a logistic regression model, and wherein determining whether the user-generated avatar body is violative of content policy of the virtual platform is based on a weighted combination of the probability values.

13. The computer-implemented method of claim 1, wherein the multimodal machine-learned model is a vision-language model pretrained to analyze visual and text input.

14. The computer-implemented method of claim 13, further comprising training the multimodal machine-learned model based on a dataset of training avatar bodies that includes policy-violating training bodies and non-policy-violating training bodies.

15. A computing device comprising:
one or more processors; and
memory coupled to the one or more processors storing instructions that, when executed by the one or more processors, cause the one or more processors to perform operations comprising:
obtaining a user-generated avatar body on a virtual platform, wherein the user-generated avatar body includes a 3D mesh and texture;
providing the user-generated avatar body and a plurality of text questions to a multimodal machine-learned model, wherein each text question relates to a characteristic associated with avatar bodies on the virtual platform;
obtaining, as output of the multimodal machine-learned model, a respective probability value associated with each of the text questions, wherein the respective probability value indicates whether the user-generated avatar body possesses the characteristic;
determining, based on the probability values and using a decision model, whether the user-generated avatar body is violative of content policy of the virtual platform; and
controlling usage of the user-generated avatar body on the virtual platform based on the determination of whether the user-generated avatar body is violative of content policy.

16. The computing device of claim 15, wherein providing the user-generated avatar body to the multimodal machine-learned model comprises:
generating one or more images of the user-generated avatar body that depict the user-generated avatar body in respective poses; and
providing the one or more images of the user-generated avatar body to the multimodal machine-learned model.

17. The computing device of claim 15, wherein the virtual platform includes a plurality of accessories attachable to the avatar bodies on the virtual platform, and wherein the characteristic is based on an attribute of at least one of the plurality of accessories.

18. The computing device of claim 17, wherein the instructions cause the one or more processors to perform further operations comprising:
retrieving a plurality of tags, each tag corresponding to a respective attribute associated with at least one of the plurality of accessories; and
generating, using a large language model (LLM) and based on the plurality of tags, one or more of the plurality of text questions.

19. The computing device of claim 18, wherein the instructions cause the one or more processors to perform further operations comprising:
generating one or more of the plurality of tags by automatically analyzing the accessories available on the virtual platform, wherein the accessories are user-generated virtual assets, and wherein the analyzing comprises determining respective attributes associated with the virtual assets.

20. A non-transitory computer-readable medium with instructions stored thereon that, when executed by a processor, cause the processor to perform operations comprising:
obtaining a user-generated avatar body on a virtual platform, wherein the user-generated avatar body includes a 3D mesh and texture;
providing the user-generated avatar body and a plurality of text questions to a multimodal machine-learned model, wherein each text question relates to a characteristic associated with avatar bodies on the virtual platform;
obtaining, as output of the multimodal machine-learned model, a respective probability value associated with each of the text questions, wherein the respective probability value indicates whether the user-generated avatar body possesses the characteristic;
determining, based on the probability values and using a decision model, whether the user-generated avatar body is violative of content policy of the virtual platform; and
controlling usage of the user-generated avatar body on the virtual platform based on the determination of whether the user-generated avatar body is violative of content policy.
